(19) United States
(12) Patent Application Publication
(10) Pub. No.: US 2010/0043427 A1
(43) Pub. Date: Feb. 25, 2010

(54) POWER TRANSMISSION MECHANISM AND EXHAUST HEAT RECOVERY APPARATUS

(75) Inventors: Daisaku Sawada, Shizuoka-ken (JP); Hiroshi Yaguchi, Shizuoka-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Toyota-shi (JP)

(21) Appl. No.: 12/593,929

(22) PCT Filed: Apr. 3, 2008
(86) PCT No.: PCT/IB08/00798

§ 371 Date: Sep. 30, 2009

(30) Foreign Application Priority Data
Apr. 5, 2007 (JP) 2007-099696

(51) Int. Cl. F02G 5/02; F16D 27/02

(52) U.S. Cl. 60/597; 464/29

(57) ABSTRACT

A power transmission mechanism that transfers power from an output shaft disposed in sealed-off space within a power generation unit includes: a drive shaft to which the power from the output shaft is transmitted; a first magnet that is fitted to the drive shaft and that rotates together with the drive shaft; a second magnet that is fitted to a driven shaft, which is arranged concentrically with the drive shaft, that is disposed outside the sealed-off space, and that faces the first magnet; and a partition wall that is interposed between the first magnet and the second magnet, and that separates a drive shaft side space and a driven shaft side space from each other.

### BACKGROUND OF THE INVENTION

1. Field of Invention

The invention relates to a power transmission mechanism that transfers power from an output shaft disposed in a sealed-off space to the outside of the sealed-off space, and an exhaust heat recovery apparatus that uses the power transmission mechanism.

2. Description of Related Art

There is an exhaust heat recovery apparatus that recovers, by using a heat engine, exhaust heat of an internal combustion engine mounted in a vehicle, for example, an automobile, a bus, or a truck. An example of such exhaust heat recovery apparatus is an external combustion engine, for example, a Stirling engine, which has excellent theoretical thermal efficiency. Japanese Patent Application Publication No. 2005-351242 (JP-A-2005-351242) and Japanese Patent Application Publication No. 2005-351243 (JP-A-2005-351243) each describe a Stirling engine for recovering exhaust heat. The Stirling engine has a hermetically sealed crankcase, and the pressure inside the crankcase is boosted to increase the power output from the Stirling engine.

Because the Stirling engine described in each of JP-A-2005-351242 and JP-A-2005-351243 has a hermetically sealed crankcase, a crankshaft needs to be provided with a seal in order to maintain the hermeticity. The seal is required to have high sealing performance so as to prevent a decrease in the pressure within the crankcase. If the sealing performance improves, however, a sliding resistance between a power transmission shaft and the seal also increases, resulting in an increase of friction loss. Because heat energy is recovered from a low-temperature heat source when exhaust heat is recovered, the amount of energy that is obtained from the Stirling engine will be reduced if the friction loss occurs. However, each of JP-A-2005-351242 and JP-A-2005-351243 does not mention the friction loss due to sealing, and this problem is yet to be solved.

### SUMMARY OF THE INVENTION

The invention provides a power transmission mechanism and an exhaust heat recovery apparatus with which friction loss that may be caused when power is transferred from a sealed-off space is minimized.

A first aspect of the invention relates to a power transmission mechanism that transfers power from an output shaft disposed in sealed-off space within a power generation unit. The power transmission mechanism includes: a drive shaft to which the power from the output shaft is transmitted; a first magnet that is fitted to the drive shaft and that rotates together with the drive shaft; a second magnet that is fitted to a driven shaft arranged concentrically with the drive shaft, that is disposed outside the sealed-off space, and that faces the first magnet; and a partition wall that is interposed between the first magnet and the second magnet, and that separates a drive shaft side space and a driven shaft side space from each other.

The power transmission mechanism transfers the power from the output shaft disposed in the sealed-off space within the power generation unit to the outside of the sealed-off space by using a magnetic force generated between the first and the second magnet. Therefore, it is possible to minimize the friction loss that may be caused when the power is transferred to the outside of the sealed-off space.

In the first aspect of the invention, the sealed-off space may be an inner space within an external combustion engine, and the output shaft may be disposed within the external combustion engine.

In the first aspect of the invention, the external combustion engine may be a Stirling engine.

In the first aspect of the invention, a conversion unit, which adjusts a torque from the output shaft and transfers the adjusted torque to the drive shaft, may be provided between the output shaft and the drive shaft.

In the first aspect of the invention, the conversion unit may reduce the torque from the output shaft and transmit the reduced torque to the drive shaft.

In the first aspect of the invention, the conversion unit may be a speed increasing unit that reduces the torque from the output shaft by increasing a rotational speed of the output shaft and transfers the reduced torque to the drive shaft.

In the first aspect of the invention, the partition wall may be made of a non-conductive material.

The power transmission mechanism according to the first aspect of the invention may further include: a lubrication target component arranged space in which a component that is included in the conversion unit and that needs lubrication is arranged so that the component is sealed off from the sealed-off space within the power generation unit; and a pressure difference absorbing unit that absorbs a difference between an inner pressure within the sealed-off space and an inner pressure within the lubrication target component arranged space.

The power transmission mechanism according to the first aspect of the invention may further include a communication passage that provides communication between the sealed-off space and a space surrounded by the partition wall.

A second aspect of the invention relates to an exhaust heat recovery apparatus that includes: a power generation unit that converts heat energy of exhaust heat discharged from a heat engine into kinetic energy and outputs the energy through an output shaft in a form of rotational motion; and the power transmission mechanism according to the first aspect of the invention, which transfers the power from the output shaft of the power generation unit.

With the power transmission mechanism and the exhaust heat recovery apparatus according to the above-described aspects of the invention, friction loss that may be caused when the power is transferred from the sealed-off space is minimized.

### BRIEF DESCRIPTION OF THE DRAWINGS

The above and other objects and features of the invention will become apparent from the following description of an example embodiment, given in conjunction with the accompanying drawings in which:

FIG. 1 is a cross-sectional view showing a Stirling engine which serves as a power generation unit and an exhaust heat recovery apparatus according to an embodiment of the invention;

FIG. 2 is a cross-sectional view showing an example of the structure of a gas bearing of the Stirling engine which serves as a power generation unit and an exhaust heat recovery apparatus according to the embodiment of the invention;

FIG. 3 is an explanatory view showing an example of an approximate linear mechanism that is used to support a piston;

FIG. 4 is a view showing the structure of a power transmission mechanism of the Stirling engine according to the embodiment of the invention;

FIG. 5 is a cross-sectional view taken along the line A-A in FIG. 4, which shows the structure of a magnetic coupling of the power transmission mechanism according to the embodiment of the invention;

FIGS. 6A to 6C are views showing a modified example of the magnetic coupling which is applicable to the power transmission mechanism according to the embodiment of the invention;

FIG. 7 is a view showing the structure of a modified example of the power transmission mechanism of the Stirling engine according to the embodiment of the invention;

FIG. 8 is a view showing the state in which the Stirling engine according to the embodiment of the invention is mounted in a vehicle; and

FIG. 9 is a view showing the structure with which exhaust heat is recovered from an exhaust gas discharged from an internal combustion engine of the vehicle by using the Stirling engine according to the embodiment of the invention.

### DETAILED DESCRIPTION OF EXAMPLE EMBODIMENT

An example embodiment of the invention will be described with reference to the accompanying drawings. Note that the invention is not limited to the example embodiment described below. Some components described in the following embodiment are readily conceived by those who are skilled in the art or substantially identical with conventional ones. The following description will be provided concerning a situation where a Stirling engine, which is an external combustions engine, is used as a power generation unit and an exhaust heat recovery apparatus, and heat energy is recovered from the exhaust gas discharged from an internal combustion engine, which is a heat engine. Instead of the Stirling engine, an external combustion engine that uses a Brayton cycle may also be used as a power generation unit and an exhaust heat recovery apparatus. Further, the types of heat engines from which exhaust heat is recovered are not particularly limited.

The example embodiment of the invention relates to a power transmission mechanism and an exhaust heat recovery apparatus that uses the power transmission mechanism. According to the embodiment of the invention, power is transferred from a crankshaft disposed in a sealed-off space to the outside of the sealed-off space via a magnetic coupling. An example of such sealed-off space is a space within a crankcase of a Stirling engine, which serves as a power generation unit. The power transmission mechanism according to the embodiment of the invention may be suitably used for an external combustion engine or a Stirling engine. First, the structure of a Stirling engine 100 that serves as the power generation unit and the exhaust heat recovery apparatus according to the embodiment of the invention will be described below.

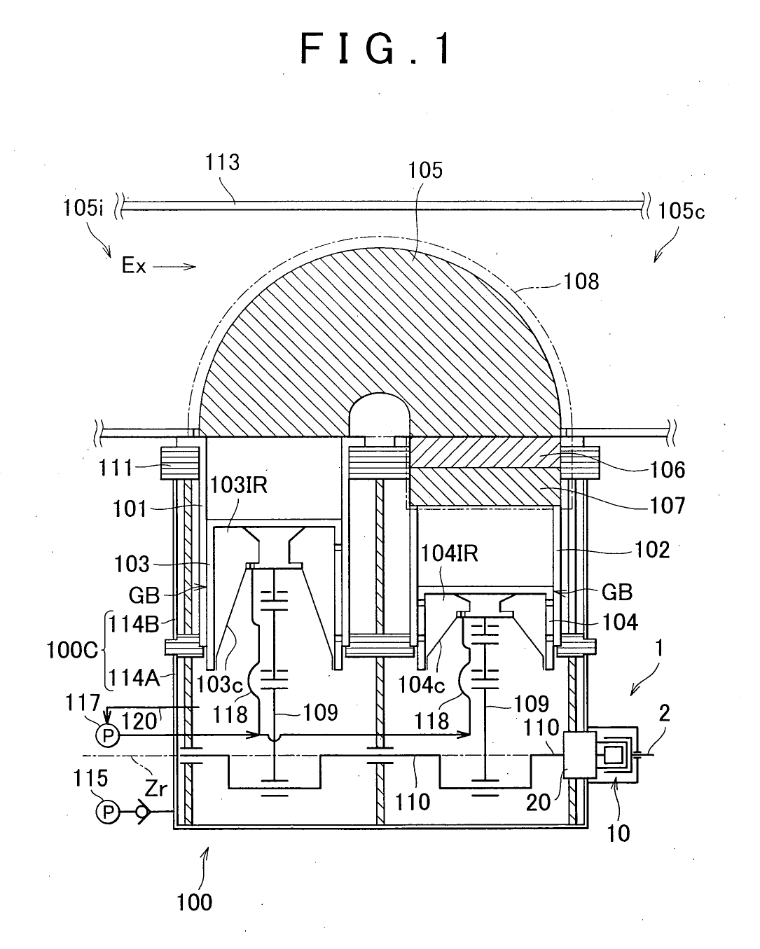

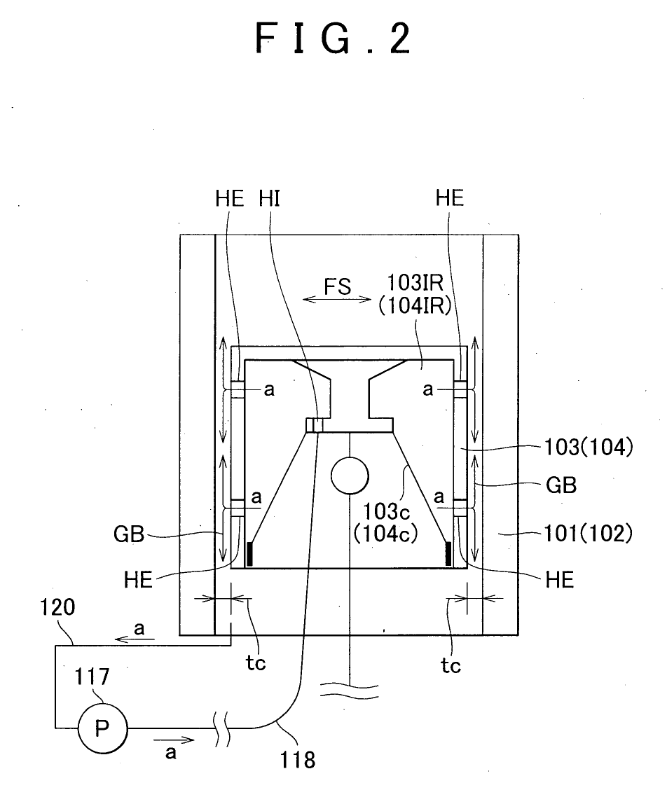

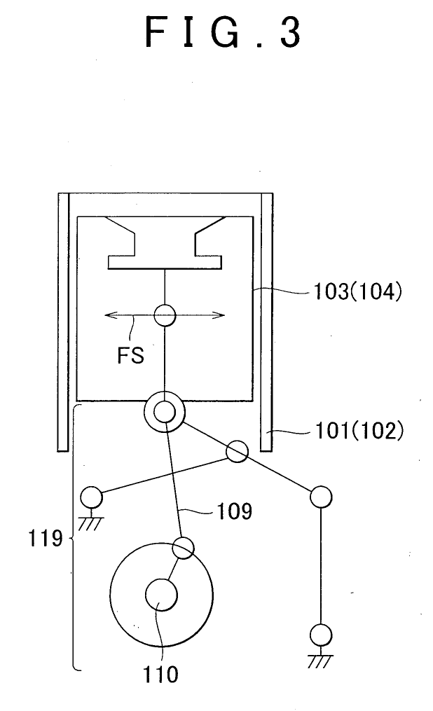

FIG. 1 is a cross-sectional view showing the Stirling engine 100 that serves as the power generation unit and the exhaust heat recovery apparatus according to the embodiment of the invention. FIG. 2 is a cross-sectional view showing an example of the structure of a gas bearing of the Stirling engine 100. FIG. 3 is an explanatory view showing an example of an approximate linear mechanism that is used to support a piston. The Stirling engine 100 is a so-called external combustion engine. The Stirling engine 100 converts heat energy of, for example, exhaust gas into kinetic energy, i.e., rotational motion of a crankshaft 110. The crankshaft 110 rotates about a rotational axis Zr.

The Stirling engine 100 according to the embodiment of the invention is an α-type inline two-cylinder Stirling engine. In the Stirling engine 100, a high-temperature piston 103, which serves as a first piston, is housed in a high-temperature cylinder 101 that serves as a first cylinder. A low-temperature piston 104, which serves as a second piston, is housed in a low-temperature cylinder 102 that serves as a second cylinder. The high-temperature piston 103 and the low-temperature piston 104 are arranged in line.

The high-temperature cylinder 101 and the low-temperature cylinder 102 are directly or indirectly supported by and fixed to a base plate 111, which is a reference body. In the Stirling engine 100 according to the embodiment of the invention, the base plate 111 serves as a positional reference for each component of the Stirling engine 100. This structure secures a relative position of each component precisely.

As will be described below, the Stirling engine 100 according to the embodiment of the invention has gas bearings GB between the high-temperature cylinder 101 and the high-temperature piston 103, and between the low-temperature cylinder 102 and the low-temperature piston 104. Directly or indirectly fitting the high-temperature cylinder 101 and the low-temperature cylinder 102 to the base plate 111, which serves as the reference body, makes it possible to accurately maintain clearances between the pistons and the cylinders, so that the gas bearings GB exert their effects sufficiently. In addition, the assembly of the Stirling engine 100 can be facilitated.

Disposed between the high-temperature cylinder 101 and the low-temperature cylinder 102 is a heat exchanger 108 including a substantially U-shaped heater (heating device) 105, a regenerator 106 and a cooler 107. Forming the heater 105 into a substantially U-shape makes it possible to readily arrange the heater 105 even in a arrow space, for example, a space within an exhaust gas passage of an internal combustion engine. In addition, arranging the high-temperature cylinder 101 and the low-temperature cylinder of the Stirling engine 100 in line makes it possible to relatively easily arrange the heater 105 in a cylindrical space, for example, the space within the exhaust gas passage of the internal combustion engine.

The heater 105 is arranged in such a manner that one end thereof is on the high-temperature cylinder 101 side, and the other end thereof is on the regenerator 106 side. The regenerator 106 is arranged in such a manner that one end thereof is on the heater 105 side, and the other end thereof is on the cooler 107 side. The cooler 107 is arranged in such a manner that one end thereof is on the regenerator 106 side, and the other end thereof is on the low-temperature cylinder 102 side.

Further, a working fluid (air, in the embodiment) is sealed in each of the high-temperature cylinder 101, the low-temperature cylinder 102 and the heat exchanger 108. A Stirling cycle is formed by heat supplied from the heater 105 and heat exhausted from the cooler 107, whereby power is generated by the Stirling engine 100. Each of the heater 105 and the cooler 107 may be a bundle of multiple tubes made of material having high heat conductivity and excellent heat resistance. The regenerator 106 may be made of porous heat storage material. The structures of the heater 105, the cooler 107 and the regenerator 106 are not limited to the above-mentioned examples. Other appropriate structures may be employed depending on the heat condition of a component from which exhaust heat is recovered and the specifications of the Stirling engine 100.

The high-temperature piston 103 and the low-temperature piston 104 are arranged in and supported by the high-temperature cylinder 101 and the low-temperature cylinder 102, respectively, via the gas bearings GB. That is, without using lubricating oil, the pistons are allowed to reciprocate within the cylinders. Therefore, friction between the pistons and the cylinders may be reduced, which improves the thermal efficiency of the Stirling engine 100. Further, reducing the friction between the pistons and the cylinders makes it possible to drive the Stirling engine 100 to recover heat energy even when the exhaust heat is recovered from low-temperature heat sources such as an internal combustion engine or when the heat energy is recovered under the condition where the difference in temperature between the high-temperature cylinder 101 and the low-temperature cylinder 102 is small.

In order to form the gas bearing GB, a clearance t_{c} of several tens of micrometers (μm) is created between the high-temperature piston 103 and the high-temperature cylinder 101 along the entire periphery of the high-temperature piston 103, as shown in FIG. 2. Such a clearance is created also between the low-temperature piston 104 and the low-temperature cylinder 102. The high-temperature cylinder 101, the high-temperature piston 103, the low-temperature cylinder 102 and the low-temperature piston 104 may be made of, for example, easy-to-process metal material.

In the embodiment of the invention, gas (air, in this embodiment, the same as the working fluid) a is discharged through gas injection openings HE formed in sidewalls of the high-temperature piston 103 and the low-temperature piston 104, whereby the gas bearings GB are formed. Next, the structure will be described in further detail. As shown in FIGS. 1 and 2, a partition member 103c and a partition member 104c are disposed inside the high-temperature piston 103 and the low-temperature piston 104, respectively. Inside the high-temperature piston 103, there is formed a space (high-temperature piston inner space) 103IR enclosed by a piston head, the piston sidewall and the partition member 103c. Similarly, inside the low-temperature piston 104, there is formed a space (low-temperature piston inner space) 104IR enclosed by a piston head, the piston sidewall and the partition member 104c.

The high-temperature piston 103 has a gas inlet opening HI through which the gas a is supplied into the high-temperature piston inner space 103IR, and the low-temperature piston 104 has a gas inlet opening HI through which the gas a is supplied into the low-temperature piston inner space 104IR. A gas supply pipe 118 is connected to each of the gas inlet openings HI. One end of the gas supply pipe 118 is connected to a gas bearing pump (P) 117, and the gas a discharged from the gas bearing pump 117 is introduced into the high-temperature piston inner space 103IR and the low-temperature piston inner space 104IR. Preferably, the pump 117 takes the gas a from the sealed-off space (i.e., from the space within a crankcase 114A shown in FIG. 1) through a gas inlet pipe 120, pressurizes the gas a, and discharges the pressurized gas into the gas supply pipe 118.

The gas a introduced into the high-temperature piston inner space 103IR and the low-temperature piston inner space 104IR is discharged through the gas injection openings HE formed in the sidewalls of the high-temperature piston 103 and the low-temperature piston 104, whereby the gas bearings GB are formed. These gas bearings GB are static-pressure gas bearings. Alternatively, a gas inlet hole may be formed in the top portion of each of the high-temperature piston 103 and the low-temperature piston 104, the gas a, which serves as the working fluid, may be introduced into the high-temperature piston inner space 103IR and the low-temperature piston inner space 104IR through the gas inlet holes, and the gas a may be discharged through the gas injection openings HE to form the gas bearings GB. That is, the gas bearings GB may be formed in various manners other than the above-described manner in which the gas is supplied from the gas bearing pump 117 into the high-temperature piston inner space 103IR and the low-temperature piston inner space 104IR, and discharged through the gas injection openings HE.

The reciprocation of the high-temperature piston 103 and the low-temperature piston 104 is transferred via connecting rods 109 to the crankshaft 110, which serves as an output shaft, and is converted into rotational motion of the crankshaft 110. Each connecting rod 109 may be supported by an approximate linear mechanism 119 (e.g., a grasshopper mechanism) shown in FIG. 3. This structure allows the high-temperature piston 103 and the low-temperature piston 104 to reciprocate approximately linearly.

If the connecting rod 109 is supported by the approximate linear mechanism 119, side force FS (force applied in the radial direction of the piston) of the high-temperature piston 103 or the low-temperature piston 104 becomes nearly zero. Thus, the high-temperature piston 103 and the low-temperature piston 104 can be sufficiently supported by the gas bearings GB having low load bearing capacity.

As shown in FIG. 1, components of the Stirling engine 100, for example, the high-temperature cylinder 101, the high-temperature piston 103, the connecting rods 109, and the crankshaft 110 are housed in a housing 100C. The housing 100C of the Stirling engine 100 includes the crankcase 114A and a cylinder block 114B. A pressurizing pump 115, which serves as a pressurizing unit, boosts the pressure in the housing 100C.

Pressurizing the working fluid inside the high-temperature cylinder 101, the low-temperature cylinder 102 and the heat exchanger 108 increases the heat capacity of each cylinder that is exhibited when the working fluid absorbs heat energy. As result, greater power may be transferred from the crankshaft 110, which is the output shaft of the Stirling engine 100.

In the Stirling engine 100 according to the embodiment of the invention, because the pressure in the housing 100C is boosted (e.g., up to approximately 1 MPa), the rotational motion of the crankshaft 110 needs to be transferred to the outside of the housing 100C while maintaining the hermetic sealing between the crankshaft 110 and the housing 100C. Therefore, in the embodiment of the invention, the power output from the crankshaft 110 is transferred to the outside of the housing 100C via a power transmission mechanism 1, as shown in FIG. 1. The power transmission mechanism 1 includes a speed increasing unit 20, which is a conversion unit that adjusts the torque of the crankshaft 110 and outputs the adjusted torque, and a magnetic coupling 10, which transfers the torque output from the speed increasing unit 20 to a driven shaft (magnetic coupling driven shaft) 2 without contact between the speed increasing unit 20 and the driven shaft 2. Next, the structure of the power transmission mechanism 1 will be described.

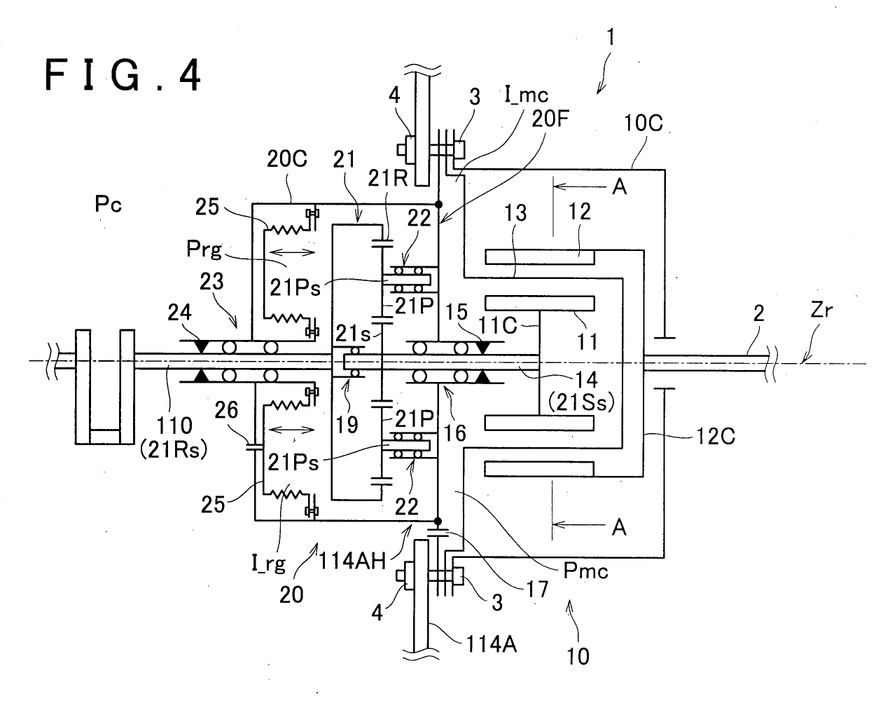

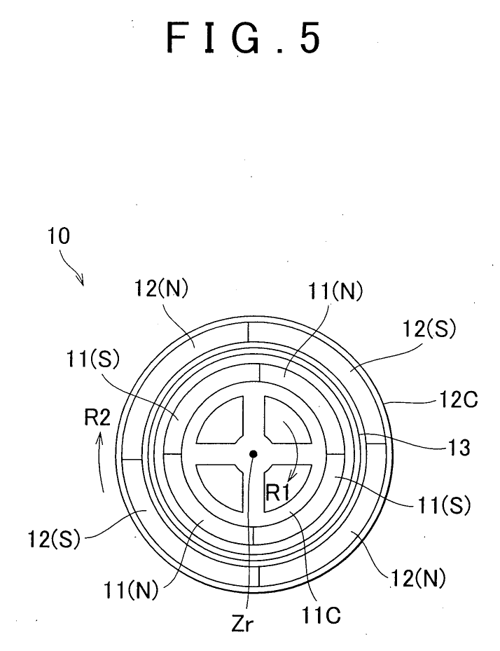

FIG. 4 is a view showing the structure of the power transmission mechanism 1 of the Stirling engine according to the embodiment of the invention. FIG. 5 is a cross-sectional view taken along the line A-A in FIG. 4, which shows the structure of the magnetic coupling 10 of the power transmission mechanism 1 according to the embodiment of the invention. The power transmission mechanism 1 according to the embodiment of the invention includes the magnetic coupling 10 and the speed increasing unit 20, and is used to transfer power from the crankshaft 110 disposed inside the crankcase 114A, which is a sealed-off space, to the outside of the crankcase 114A. The crankshaft 110, which functions as the output shaft of the Stirling engine 100, is connected to the speed increasing unit 20. The speed increasing unit 20 increases the rotational speed (number of revolutions per unit time) of the crankshaft 110 while reducing the torque from the crankshaft 10, and then inputs the power, which is generated by the Stirling engine 100 and output through the crankshaft 110, to a drive shaft (magnetic coupling drive shaft) 14 of the magnetic coupling 10.

A first magnet 11 is attached to the magnetic coupling drive shaft 14. The first magnet 11 faces a second magnet 12 attached to the magnetic coupling driven shaft 2, which is arranged coaxially with the magnetic coupling drive shaft 14. This structure allows the first magnet 11 to rotate in accordance with the rotation of the magnetic coupling drive shaft 14, and causes the second magnet 12 to rotate along with the first magnet 11 due to the magnetic force of the first magnet 11 and second magnet 12. Therefore, the power output from the magnetic coupling drive shaft 14 is transferred to the magnetic coupling driven shaft 2. That is, the power output from the Stirling engine 100 may be transferred to the outside of the crankcase 114A via the speed increasing unit 20 and the magnetic coupling 10. Next, the structure of the power transmission mechanism 1 according to the embodiment of the invention will be described in further detail.

The power generated by the Stirling engine 100 according to the embodiment of the invention is transferred from the inside of the crankcase 114A, in which the pressure has been boosted, via the magnetic coupling 10 to the outside of the crankcase 114A. Because the magnetic coupling 10 transfers the power without contact between the speed increasing unit 20 and the driven shaft 2, it is possible to reduce friction loss that may be caused when the power is transferred from the inside of the crankcase 114A, in which the pressure has been boosted, to the outside of the crankcase 114A without reducing the hermeticity of the crankcase 114A.

The magnetic coupling 10 according to the embodiment of the invention transfers power between the first magnet 11 and the second magnet 12, which faces the first magnet 11, as illustrated in FIGS. 4 and 5. The first magnet 11 is attached to the outer peripheral portion of a drive carrier 11C that is connected to the magnetic coupling drive shaft 14. The second magnet 12 is attached to the inner peripheral portion of a cup-shaped driven carrier 12C that is connected to the magnetic coupling driven shaft 2. As shown in FIG. 5, the first magnet 11 is annularly formed with S poles and N poles alternately arranged along the circumferential direction of the drive carrier 11C. Likewise, the second magnet 12 is also annularly formed with S poles and N poles alternately arranged along the circumferential direction of the driven carrier 12C.

As shown in FIGS. 4 and 5, the drive carrier 11C and the driven carrier 12C have a common rotational axis Zr, and the magnetic coupling drive shaft 14 and the magnetic coupling driven shaft 2 also have a common rotational axis Zr. That is, the drive carrier 11C, the driven carrier 12C, the magnetic coupling drive shaft 14, and the magnetic coupling driven shaft 2 have one and the same rotational axis Zr. As shown in FIG. 5, the annular first magnet 11 is disposed inside the annular second magnet 12 with a partition wall 13 interposed between the first magnet 11 and the second magnet 12. Accordingly, the second magnet 12 faces the first magnet 11. When the power generated by the Stirling engine 100 shown in FIG. 1 is transferred to the magnetic coupling drive shaft 14, the first magnet 11 is rotated in the direction of the arrow R1 in FIG. 5. Then, the magnetic force between the first magnet 11 and the second magnet 12 rotates the second magnet 12 in the direction of the arrow R2 in FIG. 5. Thus, the power is transferred from the first magnet 11 to the second magnet 12.

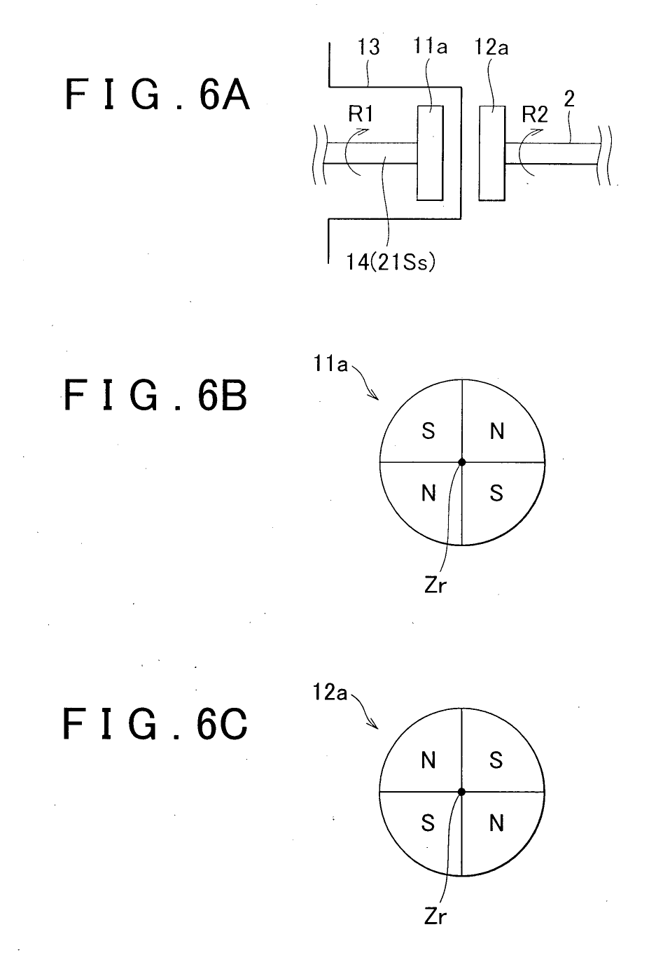

FIGS. 6A to 6C are views showing a modified example of the magnetic coupling which is applicable to the power transmission mechanism according to the embodiment of the invention. A magnetic coupling 10a includes, as shown in FIG. 6A, a disk-shaped first magnet 11a and a disk-shaped second magnet 12a, which face each other, and a partition wall 13 that is interposed between the first magnet 11a and the second magnet 12a. The first magnet 11a and the second magnet 12a are positioned such that their disk faces extend in parallel with each other. Further, as shown in FIGS. 6B and 6C, each of the first magnet 11a and the second magnet 12a has S poles and N poles alternately arranged along the circumferential direction. If the first magnet 11a is rotated in the direction of the arrow R1 in FIG. 6A, the second magnet 12a is rotated in the direction of the arrow R2 in FIG. 6A by the magnetic force between the first and the second magnet 11a and 12a. Thus, the power is transferred from the first magnet 11a to the second magnet 12a.

In the magnetic coupling 10 according to the embodiment of the invention, the partition wall 13 is disposed between the first magnet 11, which is attached to the magnetic coupling drive shaft 14, and the second magnet 12, which faces the first magnet 11 and is attached to the magnetic coupling driven shaft 2. That is, the partition wall 13 separates a space on the magnetic coupling drive shaft 14 side and a space on the magnetic coupling driven shaft 2 side from each other. With bolts 3 and nuts 4, the partition wall 13, along with a frame 20F of the speed increasing unit 20 and a magnetic coupling cover 10C, may be fitted to the crankcase 114A, at a position near an opening 114AH which is formed at a portion of the crankcase 114A around the crankshaft 110. Further, around the bolts 3, seal members may be provided between the magnetic coupling cover 10C and the partition wall 13, between the partition wall 13 and the frame 20F, and between the frame 20F and the crankcase 114A to improve the hermeticity. The magnetic coupling cover 10C is disposed outside the rotatable driven carrier 12C to prevent direct exposure of the driven carrier 12C. Thus, safety is ensured.

The inside of the partition wall 13, that is, a space enclosed by the partition wall 13 and the speed increasing unit 20 (hereinafter, referred to as “partition inner space”) I_mc and the inside of the crankcase 114A communicate with each other via a communication passage 17. Thus, a difference between an inner pressure Pmc within the partition inner space I_mc and an inner pressure Pc within the crankcase 114A is reduced to substantially equalize the two pressure levels. With this structure, the partition wall 13 separates the inside of the crankcase 114A from the outside of the crankcase 114A, where the pressure is equal to the atmospheric pressure, to ensure the hermeticity of the crankcase 114A.

Because the partition wall 13 is interposed between the rotatable first magnet 11 and the rotatable second magnet 12, an eddy current due to a change in a magnetic field may be generated depending on a material that forms the partition wall 13. In the embodiment of the invention, in order to reduce losses due to eddy currents, it is preferable to form the partition wall 13 from a non-conductive material. As described above, in the embodiment of the invention, the power generated by the Stirling engine 100 is transferred to the magnetic coupling 10 after the rotational speed of the crankshaft 110 of the Stirling engine 100 is increased. The magnitude of an eddy current increases in proportion to the square of the rotational speed.

If the partition wall 13 of the magnetic coupling 10 is formed of a non-conductive material, losses due to eddy currents hardly occur even if the rotational speed of the crankshaft 110 increases. Thus, the selection of the non-conductive material is particularly preferable when the power generated by the Stirling engine 100 is transferred to the magnetic coupling 10 after the rotational speed of the crankshaft 110 of the Stirling engine 100 is increased. When a composite material such as a fiber reinforced plastic is used to form the partition wall 13, a parent phase of the composite material or the reinforcing fiber itself may be conductive as long as the composite material as a whole is non-conductive.

For example, although a carbon fiber used as a reinforcing fiber of a carbon fiber reinforced plastic (CFRP) is conductive, a resin material used as a parent phase of the carbon fiber reinforced plastic is non-conductive. Thus, as a whole, the CFRP is regarded a non-conductive material in the embodiment of the invention. Further, because the eddy current flows on a face, no eddy current would flow if electricity flows in only one direction. Accordingly, even a conductive material may be used to form the magnetic coupling 10 in the embodiment of the invention, if the material has directionality coincident with the flow direction of the electricity.

In the embodiment of the invention, because the inner pressure Pc within the crankcase 114A is applied to the partition wall 13 of the magnetic coupling 10, the partition wall 13 need to have sufficient strength. Further, because the amount of power that can be transferred between the first magnet 11 and the second magnet 12 decreases as a distance between the first magnet 11 and the second magnet 12 increases, the distance needs to be minimized. Accordingly, the thickness of a portion of the partition wall 13, at which the first magnet 11 faces the second magnet 12, needs to be minimized.

To meet all these requirements, it is preferable to form the partition wall 13 from a fiber reinforced plastic (FRP). An example of the FRP may be a CFRP or a glass fiber reinforced plastic (GFRP). A tensile stress is imposed on the partition wall 13. Therefore, the CFRP is a material suitable for forming the partition wall 13, because a carbon fiber has a high tensile strength.

Next, the speed increasing unit 20 will be described. In the embodiment of the invention, when the power, which is generated by the Stirling engine 100 and transferred to the crankshaft 110, is transferred from the inside of the crankcase 114A to the outside of the crankcase 114A, the rotational speed of the crankshaft 110 is increased while the torque thereof is reduced, and then the reduced torque is transferred to the magnetic coupling 10. If the torque input in the magnetic coupling 10 increases, the area at which the first magnet 11 and the second magnet 12 of the magnetic coupling 10 face each other needs to be increased to increase the magnetic force that contributes to transfer of the torque.

If the area at which the first magnet 11 and the second magnet 12 faces each other increases, the area of the partition wall 13 interposed between the first magnet 11 and the second magnet 12 also increases. Therefore, in order to sustain the inner pressure within the crankcase 114A, it is necessary to increase the thickness of the partition wall 13 to ensure sufficient strength. As a result, the distance between the first magnet 11 and the second magnet 12 increases, which reduces the power transmission efficiency using the magnetic force.

In view of the above, in the embodiment of the invention, the torque that is transferred via the magnetic coupling 10 is reduced by increasing the rotational speed of the crankshaft 110, when the power generated by the Stirling engine 100 is transferred from the inside of the crankcase 114A to the outside of the crankcase 114. Accordingly, it is not necessary to increase the area at which the first and the second magnet 11 and 12 of the magnetic coupling 10 face each other and the area of the partition wall 13 interposed between the first and second magnet 11 and 12. Therefore, the partition wall 13 can sustain the inner pressure within the crankcase 114A without increasing the thickness of the partition wall 13. As a result, an increase in the distance between the first and the second magnet 11 and 12 is suppressed, and the resultant deterioration of the efficiency of power transmission using the magnetic force is suppressed. Moreover, because it is possible to avoid an increase in the size of the magnetic coupling 10, the degree of flexibility in the arrangement of the magnetic coupling 10 increases, and the marketability of the magnetic coupling 10 is improved.

In the embodiment of the invention, the speed increasing unit 20, which increases the rotational speed of the crankshaft 110, is disposed between the crankshaft 110 and the magnetic coupling 10. The speed increasing unit 20 includes a planetary gear unit 21 that serves as a speed increasing mechanism. This structure allows the crankshaft 110, the speed increasing unit 20 and the magnetic coupling 10 to be arranged coaxially, and hence the power transmission mechanism 1 is compact. Note that, the planetary gear unit 21 is just one example of the speed increasing mechanism of the speed increasing unit 20. For example, the speed increasing mechanism may be formed of a chain and a sprocket.

The planetary gear unit 21 includes a ring gear 21R, a sun gear 21S, and pinions 21P disposed between the ring gear 21R and the sun gear 21S. Pinion shafts 21Ps are attached to the pinions 21P, and are supported by pinion bearings 22. The pinion bearings 22 are provided on the frame 20F of the speed increasing unit 20, the frame 20F being fitted to a stationary member. With this structure, the pinions 21P are rotatably supported by the frame 20F via the pinion bearings 22.

The ring gear 21R is connected to the crankshaft 110 of the Stirling engine 100, and the power generated by the Stirling engine 100 and converted into the rotational motion by the crankshaft 110 is input in the ring gear 21R. The crankshaft 110 also serves as a ring gear shaft 21Rs. In this respect, the ring gear 21R serves as an input unit of the speed increasing unit 20 in which the power generated by the Stirling engine 100 is input. The crankshaft 110, i.e., the ring gear shaft 21Rs is rotatably supported by a ring gear bearing 23. The ring gear bearing 23 is attached to a speed increasing unit housing 20C, which is attached to the frame 20F. Because the frame 20F is fitted to the stationary member, the ring gear bearing 23 is also fitted to the stationary member.

The multiple pinions 21P are disposed on the inner peripheral side of the ring gear 21R that is in mesh with the pinions 21P. Further, the sun gear 21S is disposed at the center portion of the ring gear 21R, and the pinions 21P are disposed around the sun gear 21S and in mesh with the sun gear 21S. A sun gear shaft 21Ss coupled to the sun gear 21S is identical with the magnetic coupling drive shaft 14 of the magnetic coupling 10. That is, the sun gear 21S is connected to the first magnet 11 of the magnetic coupling 10 via the magnetic coupling drive shaft 14 and the drive carrier 11C. The magnetic coupling drive shaft 14, i.e., the sun gear shaft 21Ss is supported by a first sun gear bearing 16 attached to the frame 20F and a second sun gear bearing 19 attached to the center portion of the ring gear 21R.

When the power generated by the Stirling engine 100 is transferred to the ring gear 21R through the crankshaft 110 thereby rotating the ring gear 21R, the power is then transferred to the sun gear 21S via the pinions 21P. While the power generated by the Stirling engine 100 is transferred from the ring gear 21R to the sun gear 21S via the pinions 21P, the rotational speed is increased and the torque is decreased. Then, the power is transferred to the sun gear shaft 21Ss, i.e., to the magnetic coupling drive shaft 14.

The planetary gear unit 21 is formed of the multiple gears meshed with each other, and thus needs to be lubricated with lubricating oil in order to reduce sliding resistance and prevent abrasions that may occur when the gears are meshed with each other. Therefore, the planetary gear unit 21 is disposed in the speed increasing unit housing 20C, a crankcase oil seal 24 is provided between the ring gear bearing 23 and the inside of the crankcase 114A, and a magnetic coupling oil seal 15 is provided between the first sun gear bearing 16 and the partition inner space I_mc in the magnetic coupling 10. As a result, the lubricating oil is prevented from leaking to the outside of the speed increasing unit housing 20C through a gap between the ring gear bearing 23 and the ring gear shaft 21Rs and a gap between the first sun gear bearing 16 and the sun gear shaft 21Ss.

The crankcase oil seal 24 and the magnetic coupling oil seal 15 need to have a function to seal in the lubricating oil, but they need not to have a function to maintain the inner pressure within the crankcase 114A. Accordingly, because the sliding resistance that may occur between the crankcase oil seal 24 and the ring gear shaft 21Rs and the sliding resistance that may occur between the magnetic coupling oil seal 15 and the sun gear shaft 21Ss are small, losses due to sliding resistance may be suppressed.

A pressure difference between the inner pressure Pc within the crankcase 114A (which corresponds to the inner pressure Pmc within the partition inner space I_mc of the magnetic coupling 10) and the inner pressure Prg within the speed increasing unit housing 20C may be caused, depending on, for example, operational or environmental conditions for the Stirling engine 100. If the pressure difference is left, it may be no longer possible for the crankcase oil seal 24 or the magnetic coupling oil seal 15 to seal in the lubricating oil. As a result, the lubricating oil inside the speed increasing unit housing 20C may flow into the crankcase 114A or the partition inner space I_mc through the gap between the crankcase oil seal 24 and the ring gear shaft 21Rs or the gap between the magnetic coupling oil seal 15 and the sun gear shaft 21Ss.

To avoid such inconvenience, according to the embodiment of the invention, a pressure difference absorbing mechanism that absorbs the pressure difference between the inner pressure Prg within the speed increasing unit housing 20C and the inner pressure Pc within the crankcase 114A or the inner pressure P_mc within the partition inner space I_mc of the magnetic coupling 10. In the embodiment of the invention, a bellows 25, which is telescopically movable in the direction in which the rotation shaft Zr extends, is used as the pressure difference absorbing mechanism.

The bellows 25 is disposed between the inner face of the speed increasing unit housing 20C and the outer face of the ring gear bearing 23, which projects into the speed increasing unit housing 20C. The planetary gear unit 21, which is a component of the speed increasing unit 20 and which needs lubrication (i.e., a lubrication target component), is disposed in a space (lubrication target component arranged space) I_rg surrounded by the bellows 25, the speed increasing unit housing 20C and the frame 20F. Further, a communication hole 26, which communicates with the inside of the crankcase 114A, is formed between the speed increasing unit housing 20C and the inside of the crankcase 114A. Due to the presence of this communication hole 26, the inner pressure Pc within the crankcase 114A and the inner pressure within the space formed between the speed increasing unit housing 20C and the bellows 25 may be substantially equalized.

With this structure, when a pressure difference is caused between the lubrication target component arranged space I_rg and the inside of the crankcase 114A or the inside of the partition wall 13 of the magnetic coupling 10, the volume of the lubrication target component arranged space I_rg may be changed by extending and contracting the bellows 25 in the direction in which the rotation shaft Zr extends. Thus, the pressure difference may be reduced and absorbed, so that leakage of the lubricating oil from the lubrication target component arranged space I_rg is avoided. The pressure difference absorbing mechanism is not limited to bellows 25. A diaphragm or other devices may be used as the pressure difference absorbing mechanism.

Because the component that needs lubrication, that is, the planetary gear unit 21 of the speed increasing unit 20 is sealed off from the sealed-off space within the crankcase 114A, the lubricating oil or abraded powder is prevented from entering the inside of the crankcase 114A. In the Stirling engine 100 according to the embodiment of the invention, the pistons are supported within the cylinders by the gas bearings GB. If the speed increasing unit 20 is structured in the above-described manner, it is possible to suppress occurrence of adhesion of the lubricating oil or the abraded powder to the gas bearings GB and a resultant functional deterioration of the gas bearings GB. Thus, the gas bearings GB can exert their effects sufficiently during the operation of the Stirling engine 100, so that the sliding resistance that is caused between the pistons and cylinders is reduced effectively.

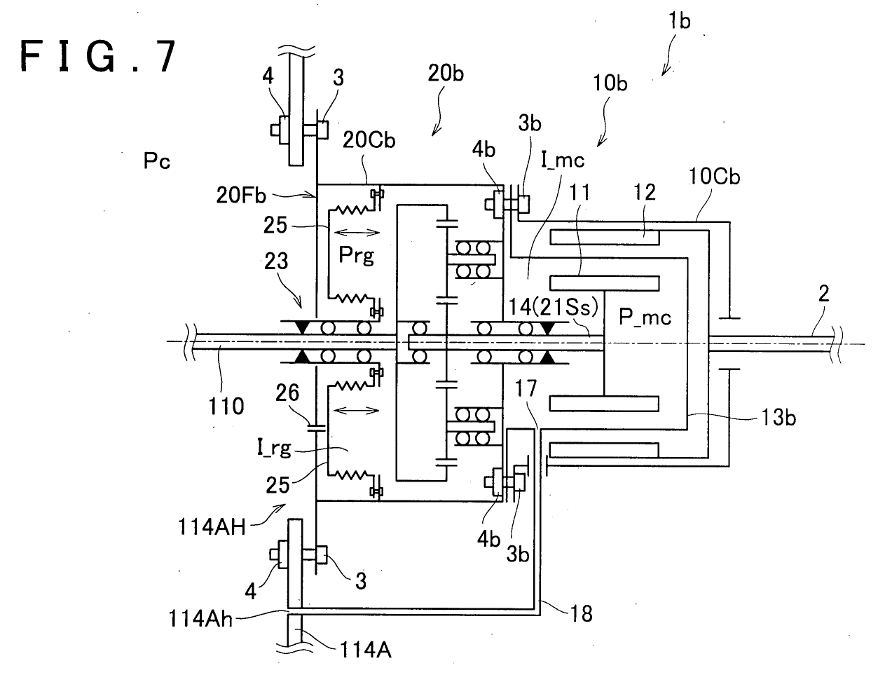

FIG. 7 is a view showing the structure of a modified example of the power transmission mechanism of the Stirling engine according to the embodiment of the invention. A power transmission mechanism 1b according to the modified example has substantially the same structure as that of the power transmission mechanism 1 shown in FIG. 4 except that a communication hole 17b formed in a partition wall 13b and a communication hole 114Ah formed in the crankcase 114A are communicated with each other through a communication passage 18 to provide communication between the partition inner space I_mc of a magnetic coupling 10b and the inside of the crankcase 114A.

In the power transmission mechanism 1b according to the modified example, a speed increasing unit 20b is disposed outside the crankcase 114A, unlike in the power transmission mechanism 1 shown in FIG. 4. Accordingly, even if the speed increasing unit 20b cannot be disposed in the crankcase 114A, it is possible to increase the rotational speed of the crankshaft 110 and transfer the power to the magnetic coupling 10b. To dispose the speed increasing unit 20b outside the crankcase 114A, the magnetic coupling 10b is attached to a speed increasing unit housing 20Cb at a portion on the side of the magnetic coupling drive shaft 14.

The partition wall 13b of the magnetic coupling 10b, along with a magnetic coupling cover 10Cb, is attached to the speed increasing unit housing 20Cb with bolts 3b and nuts 4b. Further, a frame 20Fb of the speed increasing unit 20b is attached to the crankcase 114A, at a position near the opening 114AH which is formed at the portion of the crankcase 114A around the crankshaft 110. Thus, the magnetic coupling 10b is disposed outside the crankcase 114A along with the speed increasing unit 20b. Therefore, by providing communication between the communication hole 17b formed in the partition wall 13b and the communication hole 114Ah formed in the crankcase 114A through the communication passage 18, the inner pressure P_mc within the partition inner space I_mc of the magnetic coupling 10b and the inner pressure Pc within the crankcase 114A are substantially equalized.

According to the embodiment of the invention, because the power transferred to the crankshaft 110 is transferred from the sealed-off space within the crankcase 114A to the outside of the sealed-off space using the magnetic coupling 10, the hermeticity is secured and the sliding resistance is reduced. Further, the power generated by the Stirling engine 100 is transferred from the crankshaft 110 to the magnetic coupling 10 after the torque is reduced by increasing the rotational speed of the crankshaft 110. Because the magnetic coupling 10 transfers the power using magnetic force, loss of synchronization may occur in the magnetic coupling 10. However, in the power transmission mechanism 1 according to the embodiment of the invention, the torque transferred via the magnetic coupling 10 may be reduced by means of the aforementioned structure, so that the possibility of occurrence of loss of synchronization is suppressed. As a result, it is possible to transfer the power from the sealed-off space within the crankcase 114A to the outside of the sealed-off space reliably.

Especially, because the Stirling engine 100 is a piston engine and a fluctuation of the torque transferred to the crankshaft 110 is great, there is a high possibility that loss of synchronization occurs. However, because the power transmission mechanism 1 transfers the power to the magnetic coupling 10 after reducing the torque, loss of synchronization is less likely to occur, and the power may be securely transferred to the outside of the crankcase 114A via the magnetic coupling 10.

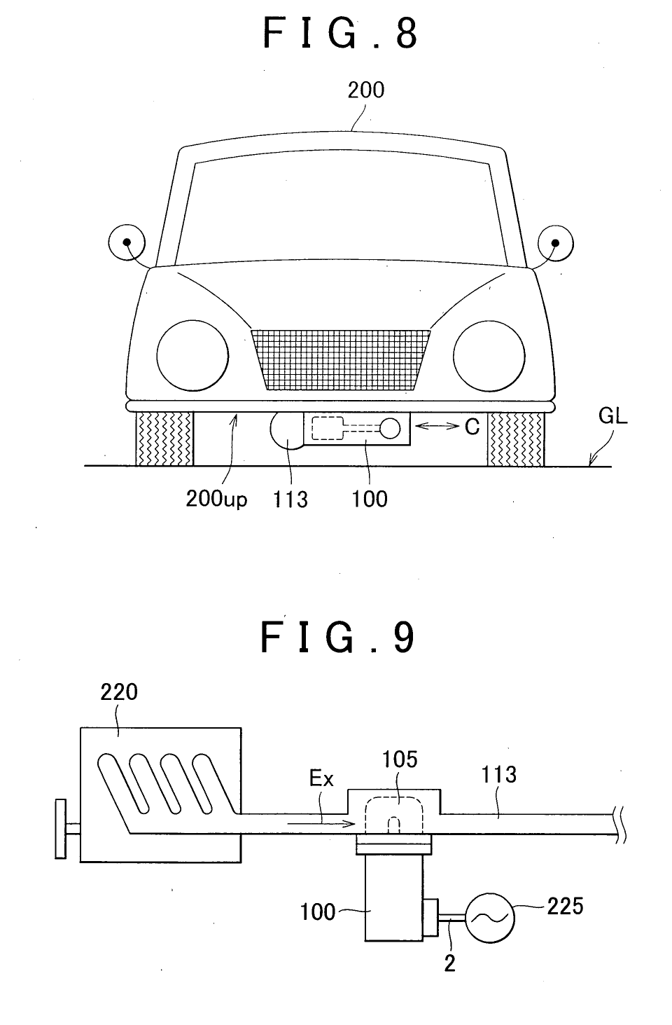

FIG. 8 is a view showing the state in which the Stirling engine according to the embodiment of the invention is mounted in a vehicle. FIG. 9 is a view showing the structure with which exhaust heat is recovered from an exhaust gas discharged from an internal combustion engine of the vehicle by using the Stirling engine according to the embodiment of the invention. As shown in FIG. 8, the Stirling engine 100 is mounted in, for example, a vehicle 200. As shown in FIG. 9, the Stirling engine 100 recovers exhaust heat from an exhaust gas Ex discharged from an internal combustion engine 220, for example, a gasoline engine, that is used as a power generator for the vehicle 200. That is, the Stirling engine 100 is driven by using the exhaust gas Ex discharged from the internal combustion engine 200 as a heat source.

As shown in FIG. 9, the heater 105 of the Stirling engine 100 is disposed in a gas exhaust pipe 113 of the internal combustion engine 220 mounted in the vehicle 200. As a working fluid is heated by heat energy recovered from the exhaust gas Ex, the Stirling engine 100 generates power. In the embodiment of the invention, the Stirling engine 100 generates power by using the exhaust gas Ex discharged from the internal combustion engine 220 as the heat source and drives a power generator 225 via the magnetic coupling driven shaft 2.

The Stirling engine 100 according to the embodiment of the invention may be attached to, for example, the bottom of the vehicle 200 as shown in FIG. 8. The Stirling engine 100 is transversely arranged in a space adjacent to the gas exhaust pipe 113 attached to the bottom of the vehicle 200. That is, the Stirling engine 100 is arranged in such a manner that the axis of each of the high-temperature cylinder 101 and the low-temperature cylinder 102 shown in FIG. 1 is substantially parallel to a vehicle bottom face 200 up. The high-temperature piston 103 and the low-temperature piston 104 reciprocate in the transverse direction (in the direction indicated by the arrow C in FIG. 8).

The Stirling engine 100 according to the embodiment of the invention is mounted in the vehicle 200 and is used to recover the exhaust heat of the internal combustion engine 220 that serves as the power generator. Therefore, the Stirling engine 100 may be affected by vibrations from a road surface GL when the vehicle 200 is traveling, resulting in occurrence of loss of synchronization in magnetic coupling 10. The power transmission mechanism 1 of the Stirling engine 100 according to the embodiment of the invention reduces the torque that is transferred to the magnetic coupling 10 by increasing the rotational speed of the crankshaft 110. Thus, it is impossible to reduce the possibility of occurrence of loss of synchronization in the magnetic coupling 10 due to the influence from the vibrations. As a result, it is possible to reliably transfer the power using the magnetic coupling 10.

According to the embodiment of the invention described above, the power is transferred from the output shaft disposed in the sealed-off space within the power generation unit to the outside of the sealed-off space via the magnetic coupling. Thus, it is possible to reduce friction loss that may be incurred when the power is transferred to the outside of the sealed-off space, and the marketability of products is improved. In particular, in the Stirling engine or in the recovery of the exhaust heat by the Stirling engine, reducing the friction loss is important to prevent a decrease in obtainable power. Therefore, the structure according to the embodiment of the invention advantageously reduces the friction loss.

As described above, the power transmission mechanism and the exhaust heat recovery apparatus according to the embodiment of the invention produce useful effects in transferring power from an output shaft disposed in a sealed-off space to the outside of the sealed-off space, especially in reducing friction loss that may occur during transmission of the power.

The example embodiment of the invention that has been described in the specification is to be considered in all respects as illustrative and not restrictive. The invention may be implemented in various other embodiments that are derived based on the knowledge of those who are skilled in the art.

1. A power transmission mechanism that transfers power from an output shaft disposed in sealed-off space within a external combustion engine, comprising:
a drive shaft to which the power from the output shaft is transmitted;
a first magnet that is fitted to the drive shaft and that rotates together with the drive shaft;
a second magnet that is fitted to a driven shaft arranged concentrically with the drive shaft, that is disposed outside the sealed-off space, and that faces the first magnet;
a partition wall that is interposed between the first magnet and the second magnet, and that separates a drive shaft side space and a driven shaft side space from each other; and
a conversion unit provided between the output shaft and the drive shaft, and which adjusts a torque from the output shaft and transfers the adjusted torque to the drive shaft,
wherein the conversion unit is a speed increasing unit that reduces the torque from the output shaft by increasing a rotational speed of the output shaft and transfers the reduced torque to the drive shaft.

2. The power transmission mechanism according to claim 1, wherein the output shaft, the drive shaft, and the driven shaft are coaxially arranged.

3. The power transmission mechanism according to claim 1, wherein the sealed-off space is an inner space within the external combustion engine, and the output shaft is disposed within the external combustion engine.

4. The power transmission mechanism according to claim 3, wherein the external combustion engine is a Stirling engine.

5. The power transmission mechanism according to claim 1, wherein the partition wall is made of a non-conductive material.

6. The power transmission mechanism according to claim 1, further comprising:
a lubrication target component arranged space in which a component that is included in the conversion unit and that needs lubrication is arranged so that the component is sealed off from the sealed-off space within the power generation unit; and
a pressure difference absorbing unit that absorbs a difference between an inner pressure within the sealed-off space and an inner pressure within the lubrication target component arranged space.

7. The power transmission mechanism according to claim 1, further comprising:
a communication passage that provides communication between the sealed-off space and a space surrounded by the partition wall.

8. The power transmission mechanism according to claim 1, wherein each of the first magnet and the second magnet has an annular shape with S poles and N poles alternately arranged along a circumferential direction of the magnet, and the first magnet is disposed inside the second magnet.

9. The power transmission mechanism according to claim 1, wherein each of the first magnet and the second magnet has a disk shape with S poles and N poles alternately arranged along a circumferential direction of the magnet, and the first magnet and the second magnet are arranged in such a manner that the disk face of the first magnet and the disk face of the second magnet extend in parallel with each other.

10. The power transmission mechanism according to claim 1, wherein the communication passage is an opening formed in the partition wall.

11. The power transmission mechanism according to claim 1, wherein the conversion unit is disposed outside the crankcase, and the communication passage includes a first opening formed in the crankcase, a second opening formed in the partition wall, and a passage that provides communication between the first opening with the second opening.

12. The power transmission mechanism according to claim 1, wherein the first magnet, the drive shaft, and the conversion unit are provided in the sealed-off space.

13. An exhaust heat recovery apparatus, comprising:
an external combustion engine that converts heat energy of exhaust heat discharged from a heat engine into kinetic energy and outputs the energy through an output shaft in a form of rotational motion; and the power transmission mechanism according to claim 1, which transfers the power from the output shaft of the power generation unit.
